(19) United States
(12) Patent Application Publication
(10) Pub. No.: US 2009/0145548 A1
(43) Pub. Date: Jun. 11, 2009

(54) Method Of Forming Printed Circuit By Printing Method

(76) Inventors: Chien-Han Ho, Taipei (TW); Yen-Chih Ho, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/953,044

(22) Filed: Dec. 8, 2007

(51) Int. Cl. B32B 38/14

(52) U.S. Cl. 156/277

(57) ABSTRACT

A method of forming a printed circuit by using a printing method is provided. Method of forming the printed circuit, which instead of using the copper etching method, uses an adhesive to adhere to the metal powder, and then to solidify the metal powder. In detail, a patterned silk screen (corresponding to the through pattern of a predetermined printed circuit wiring) and a base material are provided. The adhesive is printed onto the base material using the patterned silk screen, and an adhesive layer which is patterned is formed onto the base material. Then, the metal powder is incorporated into the adhesive layer, and solidified inside the adhesive layer to form the printed circuit.

### BACKGROUND OF THE INVENTION

1. Field of the Invention

The present invention relates generally to a method of forming a printed circuit, and in particular, to a method of forming a printed circuit by using a printing method.

2. The Prior Arts

The conventional method of manufacturing a printed circuit board (PCB) includes: transferring the electrical wiring for connecting the circuit elements onto the printed circuit layout drawing according to the circuit design; then, the circuits formed of the electrical conductive traces are achieved on the insulator board according to design, using methods such as mechanical processing and surface treatment, etc. In the conventional method, the thin copper layer is first adhered to the insulated substrate, and the predetermined pattern (e.g. trace, registration hole, and register mark) may then be formed by using the photolithography, and the etching processes, etc.

However, because of increasingly stringent environmental protection regulations, the chemical etching process that may bring forth serious amounts of pollution has to be combined with accompanying sewage treatment for treating the sewage produced during the manufacturing process, thereby leading to additional cost burdens.

In addition, when using the chemical etching process, the pH, temperature, and the etching time of the etching liquid are to be strictly controlled, so that the required predetermined printed circuits can be accurately manufactured. However, as the processing demands of the thin line manufacturing are accordingly high, it is difficult to satisfy the requirements of the thin line design. At the same time, the chemical etching process is difficult to control precisely, therefore, it is very easy to produce some deviations (e.g. such as non-uniform layer thickness) using the chemical etching process. As the number of layers increases, the cumulative deviation becomes greater, thereby resulting in the misalignment of the registration holes.

In order to solve the problems described above relating to the thinner wire issues, some manufacturers have desired to manufacture conductive trace by using the printing method and the coating of conductive adhesive, so that there would be no problems relating to etching and the corresponding pollution. However, the conductive adhesive is an adhesive blended with the metal particles, and is not made completely of conductive material; as a result, such blended material's conductance is inadequate, and typically can only be used for electrically connecting trace wires and electronic elements, etc.

### SUMMARY OF THE INVENTION

An objective of the present invention is to provide a method of forming a printed circuit by a printing method. The method mainly includes adding the metal powder into the adhesive layer, and solidifying the metal powder to form a printed circuit allowing for the ease of convenience similar to the coating of conductive adhesives, but with better electrical conductance than conductive adhesive.

According to the objective, instead of using copper etching method, the method of forming the printed circuit according to the present invention uses an adhesive to adhere to the metal powder and to solidify the metal powder. In further details, the method first provides a patterned silk screen (corresponding to the through pattern of the printed circuit which is predetermined) and a base material. The adhesive is printed on the base material by using the patterned silk screen and the adhesive layer which is patterned is then formed on the base material. Then, a metal powder is added and solidified inside the adhesive layer to form the printed circuit wiring.

### BRIEF DESCRIPTION OF THE DRAWINGS

The present invention will be apparent to those skilled in the art by reading the following detailed description of a preferred embodiment thereof, with reference to the attached drawings, in which:

FIG. 1A˜FIG. 1D are a plurality of perspective views showing a method of forming a plurality of printed circuit wiring by using a printing method in accordance with an embodiment of the present invention.

### DETAILED DESCRIPTION OF THE PREFERRED EMBODIMENT

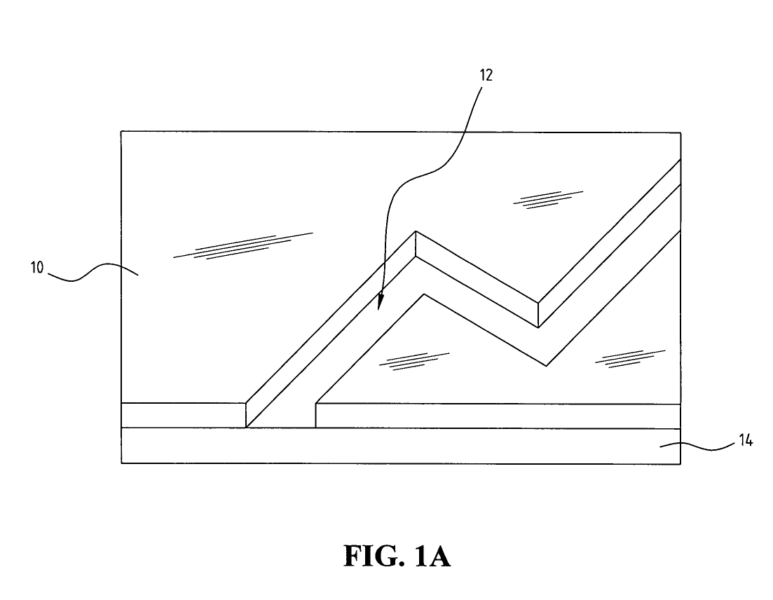

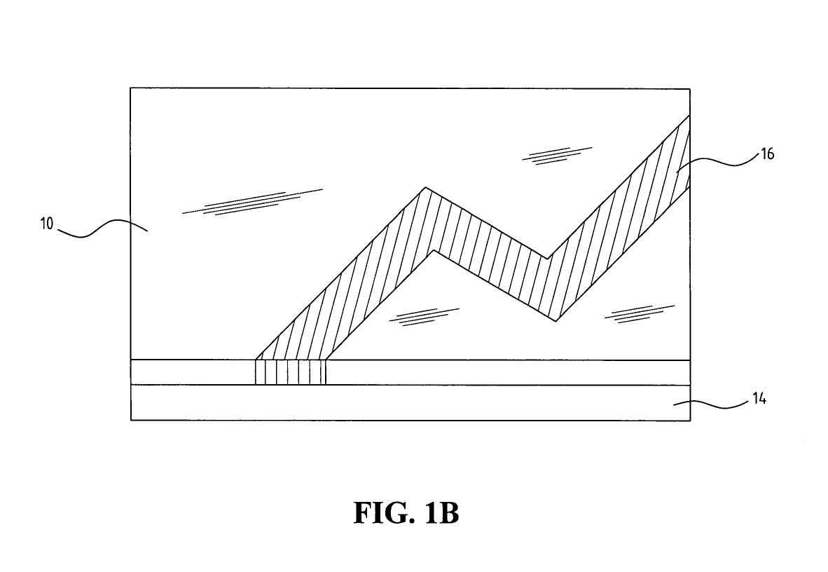

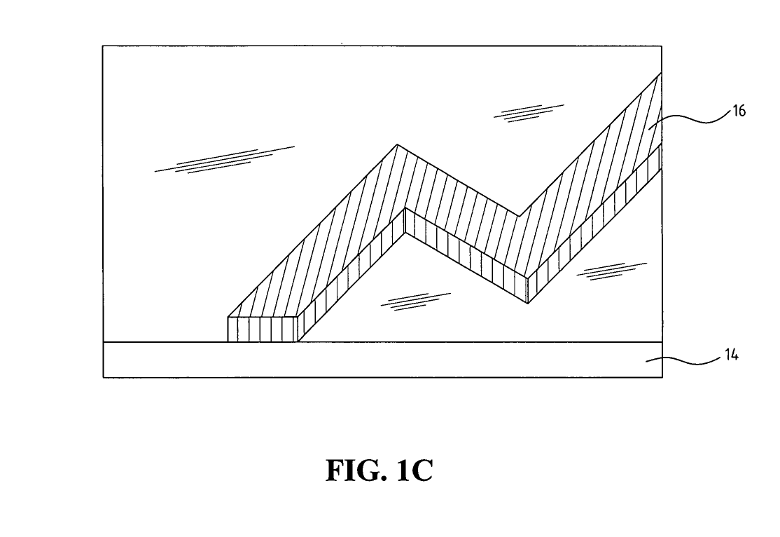

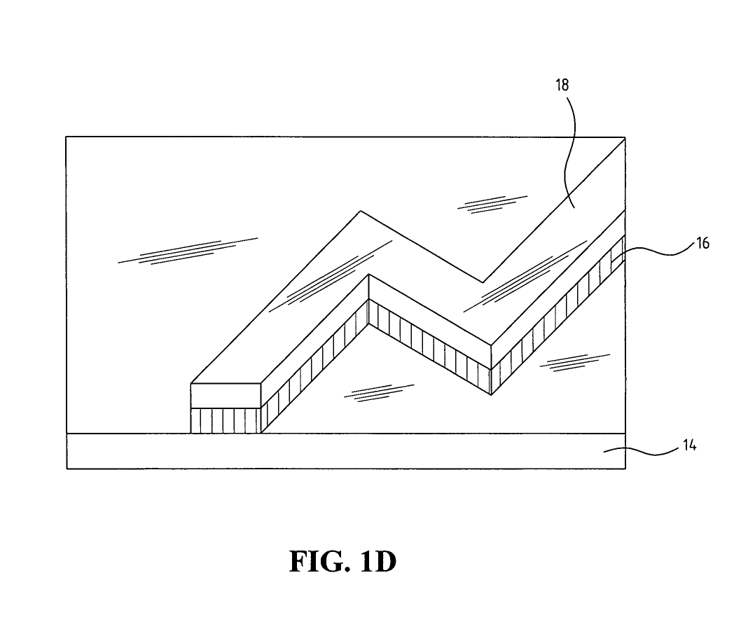

With reference to the drawings, and in particular to FIG. 1A˜FIG. 1D, FIGS. 1A˜1D are a plurality of perspective views showing a method of forming a plurality of printed circuit wiring by using the printing method. As shown in FIGS. 1A˜1D, the method of forming the printed circuit wiring is accomplished using the method as shown in FIG. 1D instead of using the copper etching process. Herein, the method in accordance with an embodiment of the present invention includes the following: a metal powder is added into the adhesive layer 16; and the metal powder is solidified to form the printed circuit 18, which provides similar convenience for ease of coating as a conductive adhesive, but offers superior electrical conductivity than the conductive adhesive.

Simply speaking, the method as shown in FIG. 1A first provides a patterned silk screen 10 (corresponding to a through pattern 12 of the predetermined printed circuit) and a base material 14. As shown in FIG. 1B, the adhesive is printed onto the base material 14 by using the patterned silk screen 10; and then an adhesive layer 16 which is patterned is formed on the base material 14, as shown in FIG. 1C. Then, a metal powder is added and then solidified inside the adhesive layer 16 to form the printed circuit wiring 18, as shown in FIG. 1D. Hereafter, the detailed manufacturing method of the patterned silk screen 10 and the incorporation method and the solidification of the metal powder will be further described.

During the manufacturing of the patterned silk screen, in accordance with the predetermined printed circuit 18, the corresponding through pattern 12 can then be manufactured onto the board, which may be a whole insulated board or a metal board, by using the stamping method, etc.

Then, the adhesive layer 16 may be formed, by which the adhesive is coated onto the base material 14 by using the patterned silk screen 10, as shown in FIG. 1B. The method for incorporating the metal powder into the adhesive layer 16 can be accomplished by spraying or spread coating the metal powder. During this process, some of the metal powder may fall outside of the adhesive layer 16, which can be taken care by a removal procedure. Thus, it is not necessary to achieve high precision during the spraying or spread coating of the metal powder onto the adhesive layer 16. Indeed, the metal powder only needs to adequately adhere to the adhesive layer 16.

After adding the metal powder into the adhesive layer 16, because there are some gaps in between the metal powder and the metal powder may not be distributed uniformly enough (which may be in the form of uneven undulations), the metal powder adhered to the adhesive layer 16 can be further solidified. The metal powder can be solidified through a heating and pressurization method (in which the processing temperature may be between 130° C. to 160° C.), so that the metal powder may be formed into the printed circuit 18 in block or strip-like structures, as shown in FIG. 1D.

In particular, during the manufacturing process, the base material 14 may possess tackiness due to softening caused by the heating process to accidentally adhere to the metal powder fallen around or outside of the adhesive layer. In order to prevent metal powder around or outside the adhesive layer from adhering to the base material, during the heating and pressurizing of the metal powder, the processing temperature cannot be set so high as to allow the base material to become tacky. Therefore, after the metal powder is solidified, the residual metal powder which is around or outside the adhesive layer is removed.

In the above method, the method of forming the printed circuit by using the printing method, without the use of the etching process, possesses no issues relating to pollution, and to have excessively thinner wires relating to the copper etching. Comparing to the conductive adhesive, the printed circuit 18 formed in accordance with the present invention has better electrical conductivity, and at the same time, has the spread coating convenience similar to the conductive adhesive.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for forming a printed circuit using a printing method, comprising:
providing a patterned silk screen, comprising a through pattern corresponding to a predetermined printed circuit;
providing a base material;
printing an adhesive onto the base material by using the patterned silk screen, and forming an adhesive layer corresponding to the through pattern;
incorporating a metal powder into the adhesive layer, and making the metal powder adhering to the adhesive layer; and
solidifying the metal powder adhered to the adhesive layer, and forming the printed circuit.

2. The method as claimed in claim 1, wherein the method for the incorporation of the metal powder into the adhesive layer is accomplished by the spraying or the spread coating method.

3. The method as claimed in claim 1, wherein the metal powder is solidified through the use of heating and pressurization.

4. The method as claimed in claim 3, wherein during the heating and pressurizing of the metal powder, the processing temperature is not to be set so high so as to make the base material to become tacky thereby preventing the metal powder around and outside the adhesive layer to adhere to the base material.

5. The method as claimed in claim 3, wherein during the heating and pressurizing of the metal powder, the processing temperature is to be between 130° C. to 160° C.

6. The method as claimed in claim 1, wherein after the metal powder is solidified, the residual metal powder around and outside the adhesive layer is removed.
